(19) United States
(12) Patent Application Publication
(10) Pub. No.: US 2002/0109893 A1
(43) Pub. Date: Aug. 15, 2002

(54) Methods and apparatus for generating return-to-zero optically encoded data stream

(76) Inventor: Mehrdad Givehchi, Boston, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 09/783,175

(22) Filed: Feb. 14, 2001

(51) Int. Cl. H04B 10/04

(52) U.S. Cl. 359/181

(57) ABSTRACT

An optical data generator for generating a return-to-zero optical data stream. The optical data generator includes a single optical modulator for receiving an input optical signal, an electrical data generator for generating a return-to-zero electrical data stream, and a driver amplifier for receiving the return-to-zero electrical data stream and providing a modulation signal representing the return-to-zero electrical data stream to the optical modulator. The optical modulator is configured to modulate the modulation signal onto the input optical signal to generate a return-to-zero optical data stream at an output port of the optical data generator.

### STATEMENT REGARDING FEDERALLY SPONSORED RESEARCH OR DEVELOPMENT

N/A

### CROSS REFERENCE TO RELATED APPLICATIONS

N/A

### BACKGROUND OF THE INVENTION

The present invention relates generally to the field of optical communication systems, and more specifically to optical data generators for generating return-to-zero optically encoded data streams.

Optical data generators are known that employ optical data streams configured in Return-to-Zero (RZ) format for generating optical data at high bit rates. A conventional optical data generator for generating RZ optical data streams comprises two (2) series-connected optical modulators, e.g., Mach-Zehnder modulators, formed on a surface of a substrate. Each optical modulator includes at least one pair of electrodes formed on the substrate surface and disposed on opposing sides of a corresponding arm of the optical modulator. Laser light is provided at the input port of the first optical modulator in the series and respective time-varying modulation signals are provided to the electrode pairs of both optical modulators. For example, a clock voltage may be provided to the electrode pair of the first optical modulator for modulation onto the laser light propagating through the first optical modulator, thereby generating a plurality of optical clock pulses at the output of the first optical modulator. Similarly, a data voltage may be provided to the electrode pair of the second optical modulator in the series for modulation onto the laser light propagating through the second optical modulator to generate at least one optical data pulse. Because the optical data pulses generated by the second optical modulator are gated with the optical clock pulses generated by the first optical modulator, an optically encoded data stream configured in the RZ format is provided at the output port of the second optical modulator.

One drawback of the above-described conventional optical data generator is that it requires two (2) optical modulators to generate an RZ optical data stream. Requiring two (2) optical modulators to generate the RZ optical data stream not only increases insertion losses but also makes the process for manufacturing the optical data generator more complicated, thereby increasing manufacturing costs. Further, in order to gate optical data pulses with optical clock pulses to generate the RZ optical data stream using the conventional optical data generator, the optical clock and data pulses must be properly phase aligned. Such phase alignment typically requires additional circuitry, e.g., phase shifters and/or analog delay lines, to phase align the respective clock and data voltages provided to the above-described first and second optical modulators. However, requiring such additional circuitry in an optical data generator can also increase the cost of manufacture. Moreover, phase aligning the clock and data voltages is often difficult to accomplish, especially when generating RZ optical data at bit rates on the order of, e.g., 10 Gbits/sec.

It would therefore be desirable to have an optical data generator for generating RZ optical data streams. Such an optical data generator would have an implementation that reduces insertion losses and is less costly to manufacture.

### BRIEF SUMMARY OF THE INVENTION

In accordance with the present invention, an optical data generator is provided for generating return-to-zero optically encoded data streams. The optical data generator includes a single optical modulator formed on a surface of a substrate. In a preferred embodiment, the optical modulator is a Mach-Zehnder modulator. The optical modulator includes at least one pair of electrodes formed on the substrate surface and disposed on opposing sides of a corresponding arm of the optical modulator. Laser light is provided at the input port of the optical modulator, and a time-varying modulation signal is provided to the pair of electrodes for modulation onto the laser light. The optical data generator includes an electrical data generator that receives respective phase aligned clock and data voltages and generates a return-to-zero electrical data stream therefrom. In a preferred embodiment, the electrical data generator comprises high speed logic circuitry configured to compute an AND function. The optical data generator further includes a driver amplifier that receives the return-to-zero electrical data stream and provides the modulation signal representing the return-to-zero electrical data stream to the pair of electrodes. The modulation signal is modulated onto the laser light propagating through the optical modulator to produce a return-to-zero optically encoded data stream at the optical modulator output port.

Other features, functions, and aspects of the invention will be evident from the Detailed Description of the Invention that follows.

### BRIEF DESCRIPTION OF THE SEVERAL VIEWS OF THE DRAWING

The invention will be more fully understood with reference to the following Detailed Description of the Invention in conjunction with the drawings of which:

FIG. 1 is a schematic diagram of a conventional optical data generator for generating a return-to-zero optically encoded data stream;

FIG. 2 is a schematic diagram of an optical data generator for generating a return-to-zero optically encoded data stream in accordance with the present invention; and

FIG. 3 is a timing diagram illustrating exemplary waveforms of various portions of the optical data generator of FIG. 2.

### DETAILED DESCRIPTION OF THE INVENTION

Methods and apparatus are disclosed for generating Return-to-Zero (RZ) optically encoded data streams. The presently disclosed invention generates such RZ optical data streams by way of an optical data generator configured to reduce insertion losses and costs of manufacture.

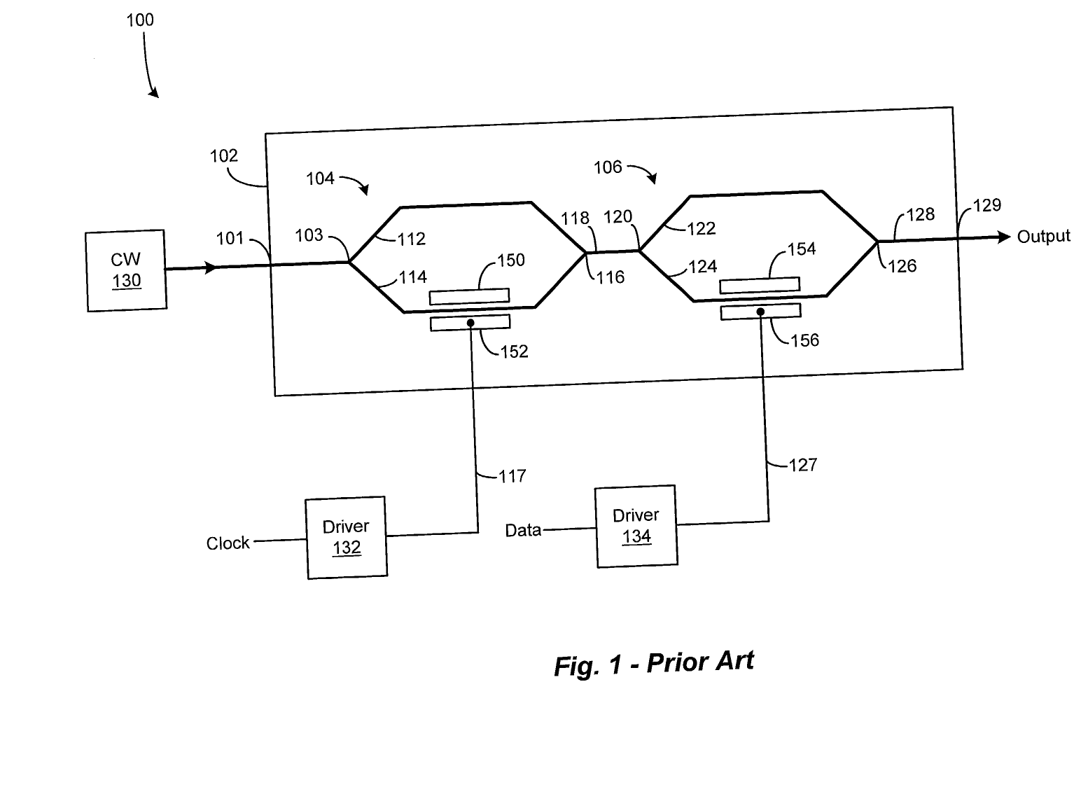

FIG. 1 depicts a schematic diagram of a conventional optical data generator 100 capable of generating RZ optical data streams. The optical data generator 100 includes an integrated optic chip 102. For example, the chip 102 may be fabricated from a substrate of lithium niobate (LiNbO₃) or any other suitable material. The chip 102 includes a pair of series-connected optical modulators 104 and 106 formed on a surface of the substrate. For example, each of the optical modulators 104 and 106 may be a Mach-Zehnder modulator. A Continuous Wave (CW) laser light source 130 provides an input optical signal at an input port 101 of the optical data generator 100. The input optical signal enters the input port 101 and is divided at a Y-junction 103 into a pair of equal components that propagate through respective arms 112 and 114 of the optical modulator 104 and recombine at a Y-junction 116. The recombined laser light propagates through a waveguide section 118 interconnecting the optical modulators 104 and 106 before being divided again at a Y-junction 120 into a second pair of equal components. These laser light components propagate through respective arms 122 and 124 of the optical modulator 106 and recombine at a Y-junction 126. The recombined laser light then propagates through a waveguide section 128 to provide an output optical signal at an output port 129 of the optical data generator 100. The conventional optical data generator 100 further includes two (2) pairs of electrodes 150, 152 and 154, 156 for use in modulating the laser light propagating through the respective optical modulators 104 and 106. Specifically, the electrode pair 150, 152 is formed on the substrate surface and disposed on opposing sides of the arm 114 of the optical modulator 104; and, the electrode pair 154, 156 is formed on the substrate surface and disposed on opposing sides of the arm 124 of the optical modulator 106. A clock voltage is provided to a driver amplifier 132, which provides a time-varying modulation signal to the electrode pair 150, 152 that is suitable for modulating the clock signal onto the component of the laser light propagating through the arm 114 of the optical waveguide 104. Similarly, a data voltage is provided to a driver amplifier 134, which provides a time-varying modulation signal to the electrode pair 154, 156 that is suitable for modulating the data signal onto the laser light component propagating through the arm 124 of the optical waveguide 106. The optical modulator 106 generates optical data pulses that are gated with optical clock pulses generated by the optical modulator 104. When the optical clock and data pulses are properly phase aligned by phase aligning the respective clock and data voltages provided to the optical modulators 104 and 106 using, e.g., a phase shifter (not shown) and/or an analog delay line (not shown), the output optical signal generated by the conventional optical data generator 100 at the output port 129 comprises an optically encoded data stream configured in the RZ format.

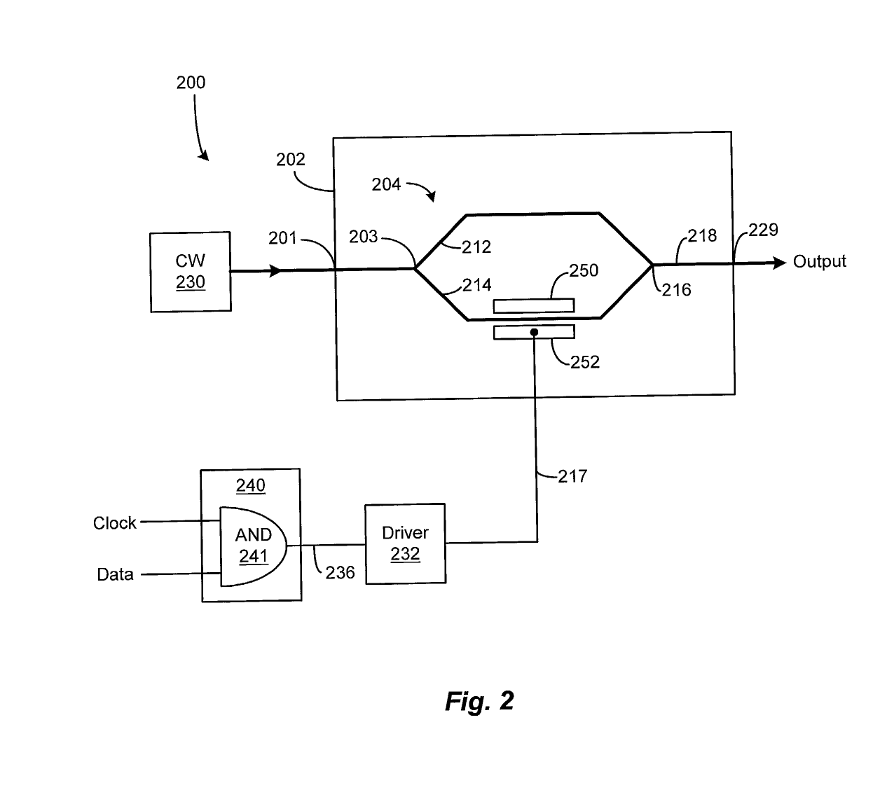

FIG. 2 depicts a schematic diagram of an illustrative embodiment of an optical data generator 200 according to the present invention. The optical data generator 200 generates an RZ optical data stream using an RZ electrical data stream to modulate laser light propagating through a single optical modulator. In the illustrated embodiment, the optical data generator 200 includes an integrated optic chip 202. For example, the chip 202 may be fabricated from a substrate of lithium niobate (LiNbO₃) or any other suitable material. The chip 202 includes a single optical modulator 204 formed on a surface of the substrate. In a preferred embodiment, the optical modulator 204 comprises a Mach-Zehnder modulator. A CW laser light source 230 provides an input optical signal at an input port 201 of the optical data generator 202. The input optical signal enters the input port 201 and is divided at a Y-junction 203 into a pair of equal components that propagate through respective arms 212 and 214 of the optical modulator 204 and recombine at a Y-junction 216. The recombined laser light propagates through a waveguide section 218 to provide an output optical signal at an output port 229 of the optical data generator 200.

The optical data generator 200 further includes a pair of electrodes 250, 252 formed on the substrate surface and disposed on opposing sides of the arm 214 of the optical modulator 204. The electrode pair 250, 252 receives a time-varying modulation signal that is suitable for modulating the laser light propagating through the optical modulator 204. Specifically, the optical data generator 200 includes an electrical data generator 240 that receives phase aligned clock and data voltages and provides an RZ electrical data stream to a driver amplifier 232 by way of a line 236. In a preferred embodiment, the electrical data generator 240 includes high speed logic circuitry, e.g., an AND gate 241, configured to compute an AND function. The driver amplifier 232 generates the time-varying modulation signal representing the RZ electrical data stream and provides the modulation signal to the electrode pair 250, 252 for modulation onto the laser light propagating through the optical modulator 204. Because the modulation signal representative of the RZ electrical data stream is modulated onto the laser light propagating through the optical modulator 204, the output optical signal generated by the optical data generator 200 at the output port 229 comprises an optically encoded data stream configured in the RZ format.

Those of ordinary skill in the art will appreciate that the modulation signal generated by the driver amplifier 232 and provided to the electrode pair 250, 252 produces an electric field that changes the relative index of refraction of the arm 214 of the optical modulator 204, thereby changing the phase relationship between the components of the input optical signal propagating through the respective arms 212 and 214. The modulation signal modulates the input optical signal by changing the phase relationship between the components of the input optical signal according to the instantaneous amplitude of the modulation signal. It is noted that changing the phase relationship between the input optical signal components results in a corresponding change in the intensity amplitude of the output optical signal generated at the output port 229 of the optical data generator 200.

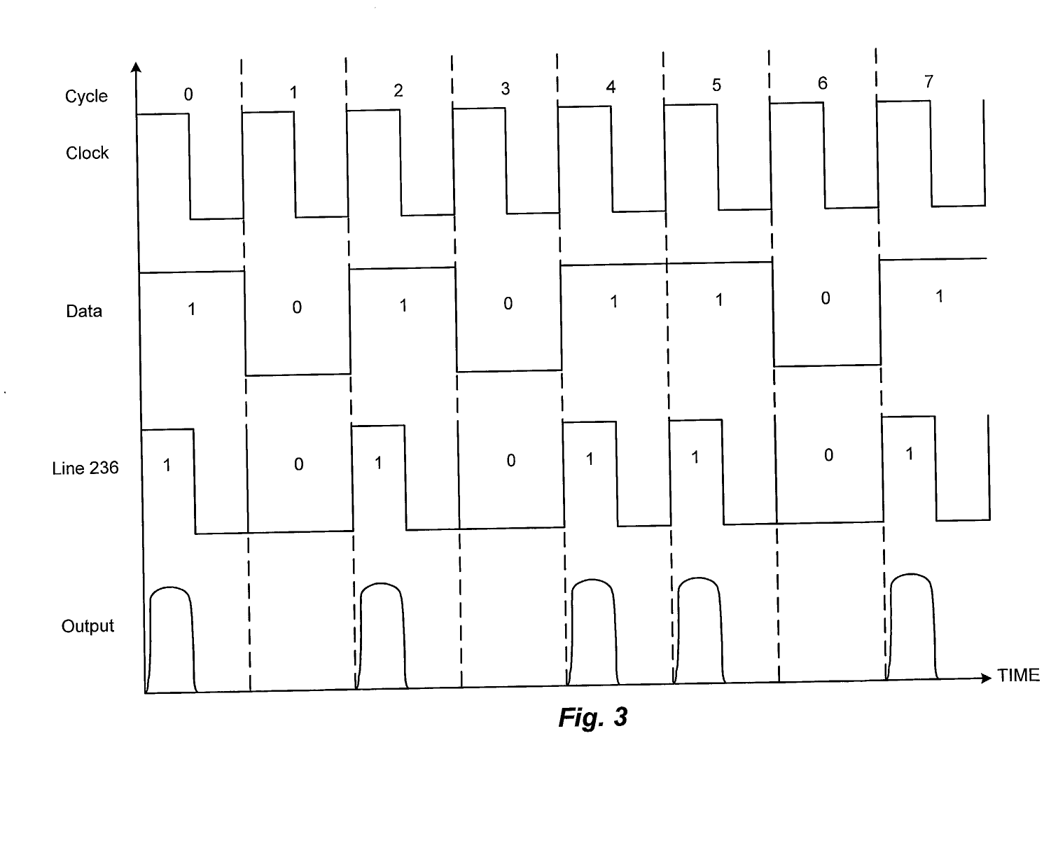

The illustrated embodiment disclosed herein will be better understood with reference to FIG. 3, which depicts exemplary waveforms of various portions of the optical data generator 200 (see FIG. 2). Specifically, FIG. 3 depicts exemplary waveforms that are representative of clock and data voltages provided to the electrical data generator 240 to generate an RZ electrical data stream on the line 236. FIG. 3 shows eight (8) cycles 0 through 7 of the exemplary clock voltage, in which each clock cycle corresponds to the desired bit time of the optical data generator 200. Further, FIG. 3 shows the exemplary data voltage phase aligned with the clock voltage. Such phase alignment of the clock and data voltages may be achieved in any conventional manner, e.g., by way of a D-type flip-flop (not shown). It is noted that the data voltage shown in FIG. 3 during the clock cycles 0 through 7 is representative of a Non-Return-to-Zero (NRZ) electrical data stream. For example, the NRZ electrical data stream includes bit values 1, 0, 1, 0, 1, 1, 0, and 1 at clock cycles 0 through 7, respectively.

Moreover, FIG. 3 shows an RZ electrical data stream generated by the electrical data generator 240 from the exemplary clock and data voltages and provided on the line 236. The RZ electrical data stream includes bit values 1, 0, 1, 0, 1, 1, 0, and 1 at the respective clock cycles 0 through 7 corresponding to the bit values of the above-mentioned NRZ electrical data stream. The driver amplifier 232 receives the RZ electrical data stream on the line 236 and generates a modulation signal suitable for modulating the RZ electrical data stream onto the laser light propagating through the optical modulator 204. In a preferred embodiment, the optical modulator 204 is operated in the approximate linear region of the transfer function of the optical modulator 204. Accordingly, the modulation signal generated by the driver amplifier 232 and provided to the optical modulator 204 preferably includes a DC component suitable for achieving such approximate linear operation of the optical modulator 204.

Finally, FIG. 3 shows an RZ optical data stream generated by the optical data generator 200 at the output port 229. The RZ optical data stream includes a plurality of optical data pulses representing the bit values 1, 0, 1, 0, 1, 1, 0, and 1 of the above-mentioned RZ electrical data stream at the respective clock cycles 0 through 7.

In a preferred embodiment, the optical data generator 200 is configured for use with Synchronous Optical NETwork (SONET) equipment capable of transmitting data at high Optical Carrier (OC) speeds. For example, for OC-192, the clock voltage (see FIG. 3) may have a frequency of 10 GHz, each of the clock cycles 0 through 7 (see FIG. 3) may have a period of 100 psecs, and the data voltage (see FIG. 3) may have a bit rate of 10 Gbits/sec. Accordingly, the clock and data voltages are preferably provided by a high speed device that can generate these signals at the required speeds and with the required phase characteristics. For example, the clock and data voltages may be provided by an OC-192 multiplexor (MUX; not shown).

Moreover, the electrical data generator 240 that receives the clock and data voltages and generates the RZ electrical data stream therefrom preferably has a suitable bandwidth. For example, the electrical data generator 240 may comprise a high speed AND gate fabricated from a GaAs or SiGe substrate using conventional techniques. Alternatively, the high speed AND gate may be incorporated in the high speed device, e.g., the OC-192 MUX, generating the clock and data voltages.

In addition, the driver amplifier 232 that receives the RZ electrical data stream and generates the modulation signal therefrom is preferably a wide-band amplifier that can compensate for the DC imbalance of the RZ data stream. For example, the driver amplifier 232 may be implemented using a conventional wide-band device having a symmetry pin for adjusting the duty cycle of the modulation signal.

Although it was described that the single optical modulator 204 of the optical data generator 200 is formed on the substrate surface of the chip 202, it is understood that the optical modulator 204 may alternatively be implemented as a discrete device.

It will further be appreciated by those of ordinary skill in the art that modifications to and variations of the above-described methods and apparatus may be made without departing from the inventive concepts disclosed herein. Accordingly, the invention should not be viewed as limited except as by the scope and spirit of the appended claims.

What is claimed is:

1. An optical data generator for generating a return-to-zero optical data stream, comprising:
an optical modulator including an input port configured to receive an input optical signal, an output port, and a modulation input;
an electrical data generator configured to generate a return-to-zero electrical data stream; and
a driver amplifier configured to receive the return-to-zero electrical data stream and provide a modulation signal representing the return-to-zero electrical data stream to the modulation input of the optical modulator,
whereby the optical modulator is configured to modulate the modulation signal onto the input optical signal to generate a return-to-zero optical data stream at the output port of the optical modulator.

2. The optical data generator of claim 1 wherein the optical modulator is formed on an integrated optic chip.

3. The optical data generator of claim 1 wherein the optical modulator is a Mach-Zehnder modulator.

4. The optical data generator of claim 1 wherein the electrical data generator includes high speed logic circuitry configured to compute an AND function.

5. The optical data generator of claim 1 wherein the optical modulator is configured to modulate the modulation signal onto the input optical signal by changing the intensity amplitude of the input optical signal according to the instantaneous amplitude of the modulation signal.

6. A method for generating a return-to-zero optical data stream, comprising the steps of:
receiving an input optical signal at an input port of an optical modulator;
generating a return-to-zero electrical data stream by an electrical data generator;
providing a modulation signal representative of the return-to-zero electrical data stream to a modulation input of the optical modulator by a driver amplifier; and
modulating the modulation signal onto the input optical signal by the optical modulator to generate a return-to-zero optical data stream at an output port of the optical modulator.

7. The method of claim 6 wherein the modulating step includes changing the intensity amplitude of the input optical signal according to the instantaneous amplitude of the modulation signal by the optical modulator.
